(19) United States
(12) Patent Application Publication
(10) Pub. No.: US 2019/0052141 A1
(43) Pub. Date: Feb. 14, 2019

(54) Production Method for Producing a Stator for a Synchronous or Asynchronous Machine

(71) Applicant: Bayerische Motoren Werke Aktiengesellschaft, Muenchen (DE)

(72) Inventors: Andreas MAYR, Waldkraiburg (DE); Dragoljub DURICIC, Muenchen (DE); Zakaria EL KHAWLY, Muenchen (DE); Thorsten RIENECKER, Muenchen (DE); Burghard BAIER, Dahlenswarsleben (DE)

(21) Appl. No.: 16/164,968

(22) Filed: Oct. 19, 2018

Related U.S. Application Data
(63) Continuation of application No. PCT/EP2017/058331, filed on Apr. 7, 2017.

(30) Foreign Application Priority Data
Apr. 21, 2016 (DE) 10 2016 206 752.4

(51) Int. Cl. H02K 3/28; H02K 1/16; H02K 3/12; H02K 15/02; H02K 15/085

(52) U.S. Cl. CPC H02K 3/28; H02K 1/16; H02K 15/085; H02K 15/024; H02K 3/12

(57) ABSTRACT

A method produces a stator provided for a synchronous or asynchronous machine having a two-layer winding. The method includes the following steps: arranging a stator body, which defines an axis of rotation for a rotor to be inserted as required into the stator, said axis of rotation extending in the longitudinal direction of the stator body, wherein the stator body has a plurality of grooves extending in the longitudinal direction; providing a plurality of coils through which a current for generating a rotating field flows when the stator is used as required; and drawing the coils into the grooves in such a way that in each case coil sides of at least two coils extend in the grooves and form the two-layer winding in that the coil sides which are radially outside with respect to the axis of rotation form a lower layer of the two-layer winding, and the coil sides which are radially inside with respect to the axis of rotation form an upper layer of the two-layer winding; wherein the coils are drawn into the grooves in such a way that the coil sides of each of the coils exclusively form either the lower layer or the upper layer.

### CROSS REFERENCE TO RELATED APPLICATIONS

This application is a continuation of PCT International Application No. PCT/EP2017/058331, filed Apr. 7, 2017, which claims priority under 35 U.S.C. § 119 from German Patent Application No. 10 2016 206 752.4, filed Apr. 21, 2016, the entire disclosures of which are herein expressly incorporated by reference.

### BACKGROUND AND SUMMARY OF THE INVENTION

The present invention relates to a production method for the production of a stator which is provided for a synchronous or asynchronous machine. The invention moreover relates to a stator which is obtainable by such a production method.

In the prior art, stators of synchronous or asynchronous machines are produced in that coils are drawn onto a carrier body and the carrier body is subsequently introduced into the stator such that the coils are drawn into corresponding grooves.

With this, in particular in the case of two-layer windings, the problem arises that final manual procedures have to be carried out to achieve the correct arrangement of the coils in the two-layer winding. For this reason, the coils cannot be drawn in fully automatically in the case of stators having two-layer windings.

Against this background, the object of the present invention is to provide a production method for the production of a stator provided for a synchronous or asynchronous machine, which enables fully automatic drawing-in of the coils—without having to perform final manual procedures.

This object is achieved by a method for the production of a stator provided for a synchronous or asynchronous machine, having a two-layer winding. The method according to the invention contains the following steps:

arranging a stator body, which defines an axis of rotation for a rotor to be inserted as intended into the stator body, which axis extents in the longitudinal direction of the stator body, wherein the stator body has a plurality of grooves extending in the longitudinal direction;
providing a plurality of coils through which a current for generating a rotating field flows when the stator is used as intended; and
drawing the coils into the grooves in such a way that coil sides of at least two coils each extend in the grooves and form the two-layer winding wherein the coil sides which are located radially outside with respect to the axis of rotation form a lower layer of the two-layer winding and the coil sides which are located radially inside with respect to the axis of rotation form an upper layer of the two-layer winding; wherein
the coils are drawn into the grooves in such a way that the coil sides of each of the coils exclusively form either the lower layer or the upper layer.

The stator body is preferably formed from a metal or a metal alloy having good electrical and magnetic properties.

The stator body is preferably designed as a hollow cylinder and has an annular cross-section in a section transversely to the axis of rotation (perpendicularly to the axis of rotation). The rotor can be inserted into the hollow cylinder as intended such that it can rotate about the axis of rotation extending in the longitudinal direction of the stator body.

The grooves are formed on the inside of the stator or hollow cylinder and extend in the longitudinal direction of the rotor.

In the method according to the invention, the coils are preferably wound by a winding machine in advance such that they have the corresponding correct dimensions for the stator body. The coils are preferably produced by winding a copper wire which is coated with an insulating varnish.

The drawing-in of the coils into the grooves takes place in particular in that the coils are arranged on a carrier body and the carrier body is subsequently drawn through the hollow cylindrical stator so that the coil sides are located within the grooves.

Within the context of this application, “coil sides” refer to the portions of the coils which are located within the grooves. This means that each coil has at least two coil sides which are located within the grooves.

According to the invention, the coils are drawn into the grooves such that the corresponding coil sides exclusively form either the lower layer of the two-layer winding or the upper layer of the two-layer winding. That is to say that the coil sides of one of the coils are not located in different layers of the two-layer winding.

It is thus possible to achieve that the coils of the stator can be drawn fully automatically into the grooves without requiring final manual steps for this.

The coils of the lower layer and/or the upper layer are preferably drawn in such that the corresponding coil sides are each distributed over at least two grooves.

The coils of the lower layer and/or the upper layer are particularly preferably each formed from a first coil and a second coil, which have different coil widths, and the first and second coil are drawn into the grooves such that coil sides of the first coil extend in grooves of the at least two grooves which are located between grooves in which coil sides of the second coil extend.

In this preferred implementation of the method, after the drawing-in of the coils, the coil sides of the second coil are located in corresponding grooves which have a certain spacing from one another. The coil sides of the first coil extend in corresponding grooves, which are located between the grooves in which the coil sides of the second coil extend. In this regard, the first coil has a smaller coil width than the second coil and is completely surrounded by the second coil. The grooves in which the coil sides of the first coil extend are preferably adjacent to the grooves in which the coil sides of the second coil extend.

The coils of the lower layer are preferably wound from a plurality of m strands, in particular m=3 strands. Likewise, the coils of the upper layer are wound from the plurality of m strands, in particular m=3 strands. The coils are drawn into the grooves such that coil sides of the coils, which form the lower layer and the upper layer, correspond to the same pole pair and belong to the same strand, extend in the same and different grooves.

In other words, the coils which belong to the same strand, correspond to the same pole pair and are located in different layers of the two-layer winding, are distributed over several grooves and are located partially above one another in that the coils are offset from one another by a number of grooves.

In particular, the coils of the lower layer and the upper layer are each formed from a first coil and a second coil, which have different coil widths.

The first and second coils are drawn into the grooves such that (i) coil sides of the first coil extend in grooves which are located between grooves in which coil sides of the second coil extend, and (ii) the coil sides of the first and second coils, which form the lower layer and the upper layer, correspond to the same pole pair and belong to the same strand, extend in the same and different grooves.

In other words, the first and second coils, which belong to the same strand, correspond to the same pole pair and are located in different layers of the two-layer winding, partially above one another, in that the coils of the lower layer and the upper layer are offset from one another such that the coil sides of the first or second coil extend in the same groove as the coil sides of the first or second coil located in the other layer in each case.

The coils are preferably drawn into the groove such that the lower layer and the upper layer are each formed from p coils, in particular p=4 coils, per strand and the coil sides extend in all grooves of the stator body.

Preferably none of the grooves therefore remains unoccupied.

The number of coils per layer and per strand is preferably greater than/equal to two coils so that the rotating field generated during operation of the stator preferably has at least two pole pairs. Each strand particularly preferably forms four coils per layer, whereby the rotating field has four pole pairs.

After the drawing-in of the coils, the first and second coils, which form the lower layer and upper layer, belong to the same strand and correspond to the same pole pair, are preferably mutually electrically connected. These mutually electrically connected first and second coils, which belong to different strands, are connected to one another at a star point.

In the method according to the invention, the coils are preferably drawn into the grooves such that the two-layer winding is chorded. In other words, the coils are not arranged or drawn into the grooves according to the pole pitch of the intended rotor.

If it is stated above that coils which are located in different layers correspond to the same pole pair, it should hereinafter be understood that these coils contribute to creating the same pole pair during operation of the stator.

The invention also relates to a stator which is obtainable according to the method according to the invention and its preferred implementations.

The stator according to the invention is, in particular, a stator which is provided for a synchronous or asynchronous machine, which is provided for operation in a motor vehicle or within motor transport.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a sectional view of a stator according to an embodiment of the invention, which is obtainable by the method according to an embodiment of the invention.

FIGS. 2A to 2C each show a plan view of a developed illustration of the stator shown in FIG. 1, wherein the winding pattern of a respective strand and the corresponding coils are shown in FIGS. 2A to 2C.

FIGS. 3A to 3D show the sequence in which the coils are drawn into a stator body of the stator.

FIG. 4 is a plan view of the developed illustration of the stator shown in FIG. 1, wherein the winding pattern of all strands is shown superimposed.

### DETAILED DESCRIPTION OF THE DRAWINGS

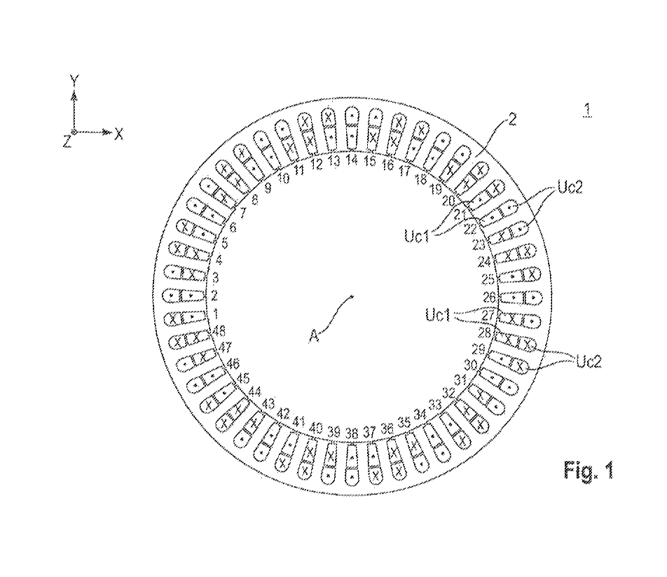

FIG. 1 shows a cross-section of a stator 1, which is obtainable by a production method. FIG. 1 moreover shows a coordinate system wherein the Z axis, which is perpendicular to the plane of the drawing, corresponds to the longitudinal direction of the stator 1.

The stator 1 contains a stator body 2, which is designed as a hollow cylinder. A rotor (not shown) can be inserted into the stator body 2 such that it can rotate about the indicated axis of rotation A. The axis of rotation A is, in turn, perpendicular to the plane of the drawing and extends in the longitudinal direction of the stator 1 or the stator body 2.

The stator 1 can be a stator for a synchronous or asynchronous machine. The dimensions of the stator 1 in the directions of the X, Y and Z axes shown are dimensioned such that the stator 1 can be used in a motor vehicle or a motor bike as part of the drive unit.

The stator body 2 contains a plurality of grooves which, in the present embodiment of the stator body 2 preferably comprise 48 grooves.

The entire winding shown in FIG. 1 is composed of a total of m=3 strands.

A plurality of coils is drawn into the grooves such that the coils occupy all grooves and form a two-layer winding. With this, some of the coils in the corresponding grooves are located radially outside with respect to the axis of rotation A and some of the coils are located radially inside with respect to the axis of rotation A. The inner coils form an upper layer of the two-layer winding and the outer coils form a lower layer of the two-layer winding.

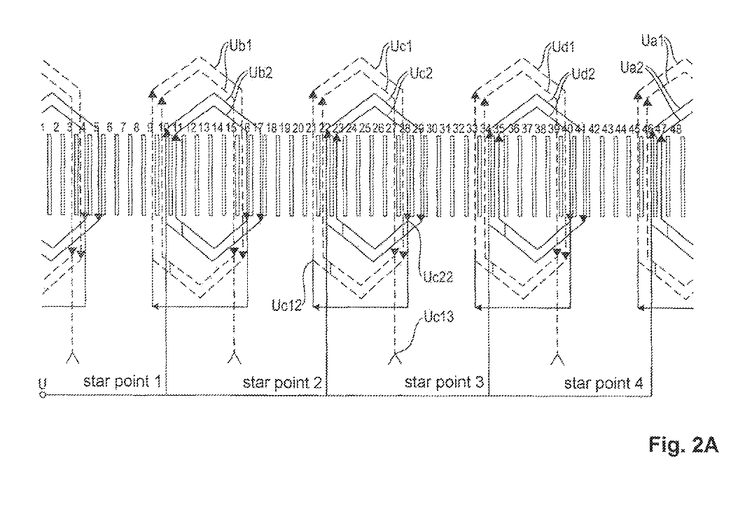

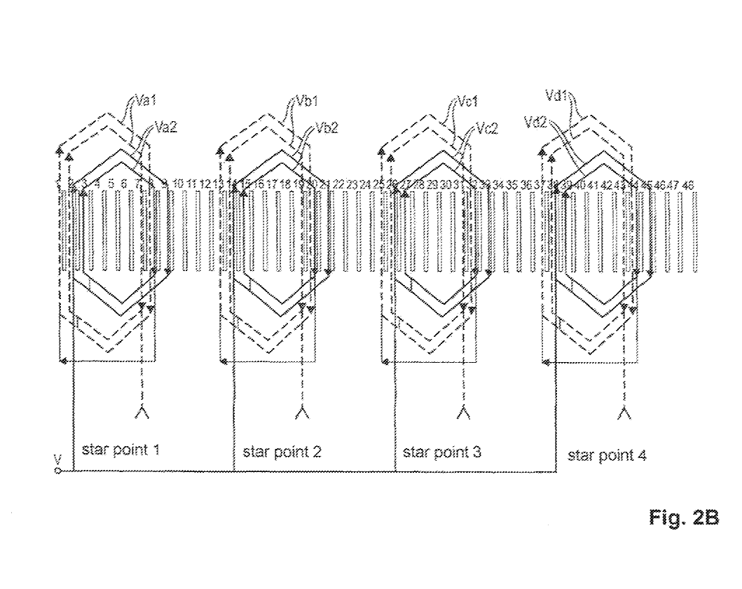

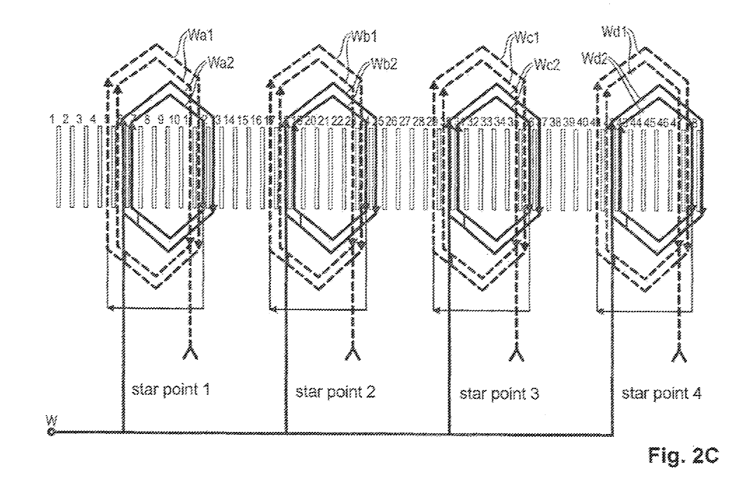

With reference to FIGS. 2A to 2C, the windings/coils for each strand are explained. The stator 1 contains, as mentioned, 3 strands which are denoted by U, V, W in FIGS. 2A to 2C.

The winding of the strand U is shown in FIG. 2A. This strand forms eight coils, wherein four of the coils are located in, or form, the upper layer and the four other coils are located, or form, the lower layer. The coils which form the upper layer are illustrated by dashed lines in FIGS. 2A to 2C and the coils which form the lower layer are illustrated by continuous lines.

During operation of the stator 1, alternating voltages, which are phase-shifted through 120° with respect to one another, are applied to the strands. Each strand has four coils per layer, which is why, during its intended operation, the stator 1 generates a rotating field which has a total of four pole pairs and drives an inserted rotor. Each of the coils located in the lower layer has a corresponding coil in the upper layer which belongs to the same strand and corresponds to the same pole pair, i.e. it contributes to creating the same pole pair during operation.

With reference to the coils Uc1, Uc2, the winding of these coils corresponding to a pole pair is explained.

The coil Uc2 is located in the lower layer of the two-layer winding, wherein this coil Uc2 is composed of a first coil and a second coil. The first coil is drawn into the grooves such that the corresponding coil sides extend through the grooves 23, 28. The second coil of the coil Uc2, on the other hand, is drawn into the grooves such that the corresponding coil sides extend through the grooves 22, 29.

In this regard, the first coil and the second coil have different coil widths, wherein the grooves of the first coil are located between those of the second coil and the second coil runs completely around the first coil.

The winding count of the first coil and the winding count of the second coil can be identical or different.

The first coil and the second coil are mutually electrically connected. This electrical connection is denoted by the reference sign Uc21 in FIG. 2A.

The coil Uc1 corresponding to the same pole pair is located in the upper layer or forms this. This coil Uc1 is likewise composed of a first coil and a second coil, which are drawn into different grooves.

The first coil of the coil Uc1 is drawn into the grooves such that the corresponding coil sides extend through the grooves 22, 27. The second coil of the coil Uc1 is drawn into the grooves such that the corresponding coil sides extend through the grooves 21, 28. In this regard, the first coil and the second coil have different coil widths, wherein the grooves of the first coil are located between those of the second coil and the second coil runs completely around the first coil.

The winding count of the first coil and the winding count of the second coil can be identical or different.

The first coil and the second coil are mutually electrically connected. This electrical connection is denoted by the reference sign Uc11 in FIG. 2A.

As a result of the coils Uc1, Uc2 of the upper and lower layer each being formed from a first and a second coil, a zone factor q=2 is produced or the coils Uc1, Uc2 are each distributed over two grooves.

The winding pattern in the case of the 48 grooves can be described in general by y={1−8/2−7}{2−9/3−8}.

Moreover, the coils Uc1, Uc2 are mutually electrically connected at the points Uc12 and Uc22. The connection of these points preferably takes place only after the drawing-in of both coils.

As is revealed from the above and shown in FIG. 2A, both coils Uc1, Uc2 are offset from one another so that a coil side of the first coil of the coil Uc1 extends in the same groove 22 as the coil side of the second coil of the coil Uc2. The same applies for groove 28, in which the coil side of the second coil of the coil Uc1 and the coil side of the first coil of the coil Uc2 extends. This is also shown in FIG. 1, which contains the corresponding reference numerals.

The coil Uc1 is connected to a star point 3. The connection point is denoted by the reference sign Uc13 in FIG. 2A.

The remaining coils of the strand U are constructed identically, simply located in other grooves of the stator body 2.

The same applies for the other strands V, W, which are constructed identically to the strand U. The coils Va1, . . . , Vd1; Va2, Vd2; Wa1, Wd1; and Wa2, Wd2 of the strands V, W are simply seated in other grooves. In this regard, the explanations relating to the strand U also apply for the strands V, W. The winding patterns of the strands V, W are shown in FIGS. 2B and 2C.

It is also shown in the respective FIGS. 2A to 2C that the entire two-layer winding is a chorded winding in which the coils do not extend in the grooves which would result from the pole pitch (8 poles/4 pole pairs).

The production method of the stator 1 explained above is described below.

In an arrangement step, the stator body 2 is inserted into a holder and held in a stable manner.

Beforehand, in parallel or afterwards, the corresponding coils which are to be drawn into the stator body are provided. For example, the corresponding coils can be wound by a winding machine immediately prior to being drawn into the stator body 2.

In a next step, the coils are drawn onto a carrier body. The carrier body is subsequently introduced into the stator body 2 along the axis of rotation A and, more precisely, in such a way that the coils are drawn into the corresponding grooves.

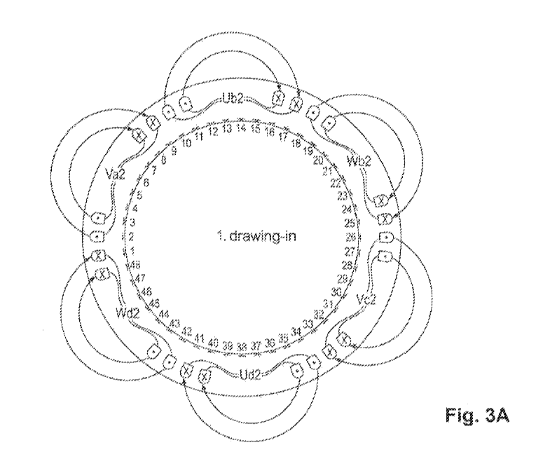

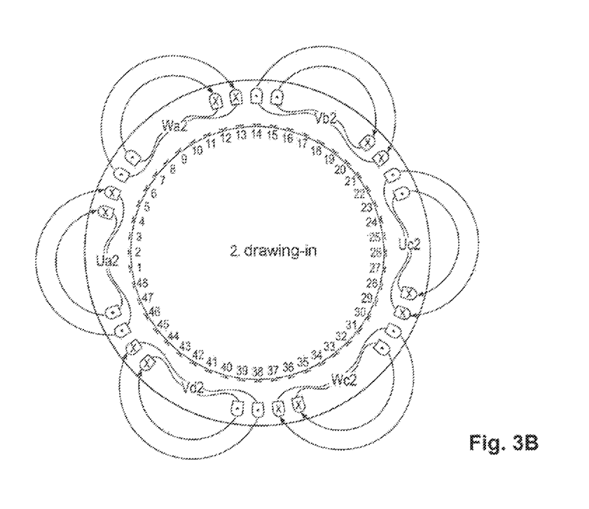

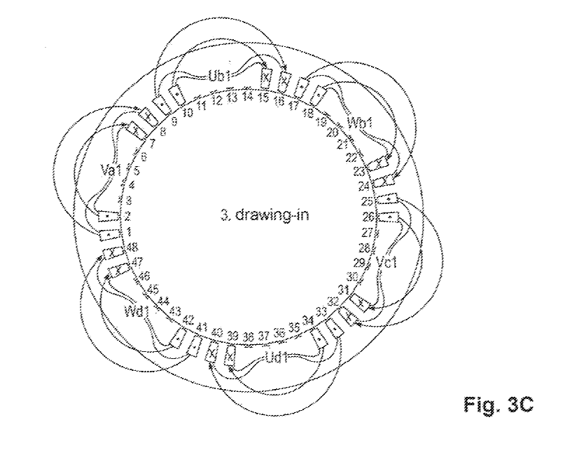

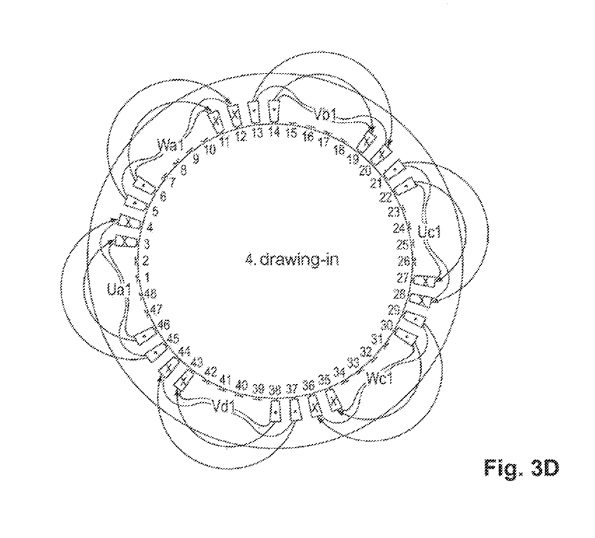

In the case of the stator 1 explained above, the coils are drawn into the grooves in sequence, wherein FIGS. 3A to 3D show the corresponding sequence.

In a first drawing-in, different coils which form the lower layer of the two-layer winding are drawn in. As shown in FIG. 3A, in the first drawing-in, the coils Ub2, Ud2 of the strand U, the coils Va2, Vc2 of the strand V and the coils Wb2, Wd2 of the strand W are drawn into the grooves together/simultaneously.

In a subsequent second drawing-in, which is shown in FIG. 3B, the coils Ua2, Uc2 of the strand U, the coils Vb2, Vd2 of the strand V and the coils Wa2, Wc2 of the strand W are drawn in together/simultaneously. After this second drawing-in, all coils which form the lower layer of the two-layer winding are drawn in completely.

In the third drawing-in shown in FIG. 3C, the coils of the upper layer have started to be drawn in. In particular, the coils Ub1, Ud1 of the strand U, the coils Va1, Vc2 of the strand V and the coils Wb1, Wd1 of the strand W are drawn in together/simultaneously here.

In the fourth and final drawing-in shown in FIG. 3D, the remaining coils of the upper layer of the two-layer winding are drawn in. In particular, the coils Ua1, Uc1 of the strand U, the coils Wa1, Wc1 of the strand W and the coils Vb1, Vd1 of the strand V are drawn into the grooves together/simultaneously here.

The connection between the coils which are located in different layers of the two-layer winding and correspond to the same pole pair, for example the coils Uc1, Uc2 shown in FIG. 2A, are connected to one another after the fourth drawing-in.

Beforehand, in parallel, or afterwards, the coils located in the upper layer are in contact with one another at the respective star points.

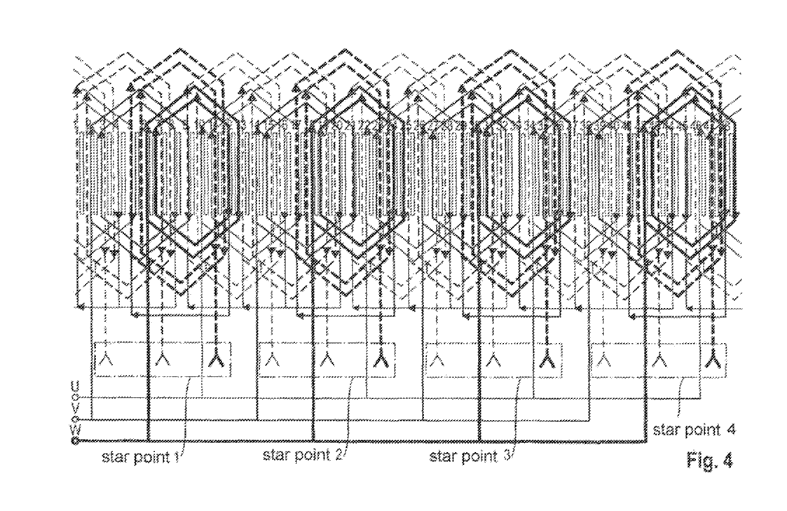

The complete winding of the 3 strands U, V, W which is then produced is shown in FIG. 4, wherein the star points at which the respective coils are in contact with one another are also shown.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for producing a stator for a synchronous or asynchronous machine, having a two-layer winding, the method comprising the steps of:
arranging a stator body, which defines an axis of rotation for a rotor to be inserted as intended into the stator body, which axis extends in a longitudinal direction of the stator body, wherein the stator body has a plurality of grooves extending in the longitudinal direction;
providing a plurality of coils through which a current for generating a rotating field flows when the stator is used as intended; and
drawing the coils into the grooves such that coil sides of at least two coils each extend in the grooves and form the two-layer winding in that the coil sides which are located radially outside with respect to the axis of rotation form a lower layer of the two-layer winding and the coil sides which are located radially inside with respect to the axis of rotation form an upper layer of the two-layer winding; wherein
the coils are drawn into the grooves such that the coil sides of each of the coils exclusively form either the lower layer or the upper layer.

2. The method as claimed in claim 1, wherein
the coils of the lower layer and/or the upper layer are drawn in such that corresponding coil sides are each distributed over at least two grooves.

3. The method as claimed in claim 2, wherein
the coils of the lower layer and/or the upper layer are each formed from a first coil and a second coil, which have different coil widths, and
the first and second coil are drawn into the grooves such that coil sides of the first coil extend in grooves of the at least two grooves which are located between grooves in which coil sides of the second coil extend.

4. The method as claimed in claim 3, wherein
the coils of the lower layer are wound from a plurality of m strands,
the coils of the upper layer are wound from the plurality of m strands, and
the coils are drawn into the grooves such that coil sides of the coils, which form the lower layer and the upper layer, correspond to a pole pair and belong to the same strand, extend in the same and different grooves.

5. The method as claimed in claim 4, wherein m=3.

6. The method as claimed in claim 4, wherein m=2

7. The method as claimed in claim 5, wherein m=6

8. The method as claimed in claim 4, wherein
the coils of the lower layer and the upper layer are each formed from a first coil and a second coil, which have different coil widths,
the first and second coils are drawn into the grooves such that (i) coil sides of the first coil extend in grooves which are located between grooves in which coil sides of the second coil extend and (ii) the coil sides of the first and second coils, which form the lower layer and the upper layer, correspond to the pole pair and belong to the same strand, extend in the same and different grooves.

9. The method as claimed in claim 8, wherein m=6

10. The method as claimed in claim 4, wherein
the coils are drawn into the grooves such that the lower layer and the upper layer is each formed from p coils and the coil sides extend in all grooves of the stator body.

11. The method as claimed in claim 10, wherein p=4

12. The method as claimed in claim 10, wherein p=8

13. The method as claimed in claim 11, wherein p=12

14. The method as claimed in claim 10, wherein
after the drawing-in of the coils, the first and second coils, which form the lower and upper layer, belong to the same strand and correspond to the same pole pair, are mutually electrically connected, and
the mutually electrically connected first and second coils, which belong to different strands, are connected to one another at a star point.

15. The method as claimed in claim 14, wherein p=12

16. The method as claimed in claim 4, wherein
the coils are drawn in such that the two-layer winding is chorded.

17. A stator produced according to the method of claim 1.
